(19) United States
(12) Patent Application Publication
(10) Pub. No.: US 2009/0220676 A1
(43) Pub. Date: Sep. 3, 2009

(54) Multi-stage coating device for moulded bodies

(76) Inventor: Guenter Koerblein, Nuernberg (DE)

Correspondence Address: MARSHALL & MELHORN, LLC, FOUR SEAGATE - EIGHTH FLOOR, TOLEDO, OH, 43604, US

(21) Appl. No.: 11/919,725

(22) PCT Filed: Apr. 1, 2006
(86) PCT No.: PCT/EP2006/002993

§ 371 Date: Feb. 18, 2009

(30) Foreign Application Priority Data
May 3, 2005 (DE) 102005020992.0

(51) Int. Cl. B05D 1/02; B05B 1/02

(52) U.S. Cl. 427/2.14; 118/300; 427/424

(57) ABSTRACT

The invention relates to a quasi-continuously operating coating device for the coating of moulded bodies, in particular for pharmaceutical products, such as tablets, drops, pressed moldings and granulates. The coating device comprises a rotating coating drum, divided into several drum longitudinal sections by a transport element, whereby the introduction of the process medium for all segments occurs individually and depending on the appropriate stage of the coating process. The moulded bodies are conveyed through the drum in an axial direction by means of said transport element. In an ideal embodiment the transport element is in the form of a cylindrical screw.

The invention relates to a device as defined in the characterising clause of claim 1, i.e. a quasi-continuous coating device for coating solid forms, in particular pharmaceutical products such as tablets, dragées, pellets and granules. The coating device consists of a rotary coating drum which is divided into several segments by a transport element, the process fluids being fed individually to each segment depending on the respective stage of the coating process, and the solid forms being conveyed in axial direction through the drum by this transport element. In an ideal embodiment, this transport element is provided in the form of a vane. The invention also refers to the related process and the use of the device.

Several state-of-the-art devices for coating tablets, dragées and granules are known. Food products are usually coated to improve the optical appearance of the product but also to optimise the mechanical properties with regard to storage or consumption and to protect the product from humidity as soon as the packaging has been opened.

Besides the optically and mechanically stabilising effects in the case of pharmaceutical products such coating is usually also important in terms of physiology, i.e. to improve oral sensory perception, to facilitate swallowing, to ensure a slowed-down or fixed-time release of the active ingredients or to preserve the tablet until it has reached the site of action in the gastrointestinal tract, for example. As a rule, the coating process comprises three stages: dust removal and heating, spraying and subsequent drying of the solid forms. These coating stages are, as a rule, carried out in series (one after the other) in the same device.

In the case of pharmaceutical products, the coat must hence be adjusted very exactly, for which it is not uncommon to apply several different coating layers to meet all the aforementioned requirements. In addition, the concentrations and masses of all substances in each individual tablet are to be kept within very narrow tolerances to comply with official requirements so that up to the present day continuous processes have been the exception. Primarily two state-of-the-art systems have been described, both of which operate batchwise.

The first system includes a kind of rotating pan or tank with an opening—usually positioned in the centre—through which the solid forms are introduced. By rotation, the mass of solid forms is kept in a constant flowing and rolling motion and is evenly sprayed with a coating fluid, i.e. usually a liquid, through nozzles. During the coating process the rotational axis of the tank is aligned at an angle of approx. 30-50° to the horizontal so that the tank opening points upwards in a slanting position.

At the same time as or subsequent to being moistened with a fluid, volatile components are sucked off and the coated and moist solid forms dried. EP 0 088 317 A1 discloses such a system in which the solid forms are sprayed with coating fluid through nozzles arranged on a fixed pipe, the pipe projecting through the free opening into the inside of the tank. Extraction and drying are performed via a grid which is attached in the interior of the tank and which is largely covered by the mass when the tank is full, even during rotation.

The suction line of the device according to EP 0 088 317 A1 also runs through the aforementioned tank opening to the outside. An equivalent device is also disclosed in DE 27 31 351 A1, FR 2.222.957 A1 or in DE 24 23 933 A1. In the case of this first system, the ready-coated batch is emptied through the tank opening once the feed lines have been disconnected.

As regards the second coating system, the main parts of which are identical with the first system, the uncoated solid forms are introduced on one side or through a wall opening of a coating drum or container. In the coating process, the coating drum rotates about an essentially horizontal axis. EP 0 198 929 A1, DE 44 45 618 A1 or FR 2.053.554 A5 disclose such coating devices for solid forms.

A further state-of-the-art coating device allows the drum and drum internals to move in a number of directions so as to keep the solid forms in suspension. DE 31 49 421 A1 in connection with DE-2218729 A disclose such a unit. The mixing, agitating and conveying devices integrated into the drum serve to improve the mixing result of the drum contents but do not allow a continuous production process.

A disadvantage of the state-of-the-art devices for coating solid pharmaceutical dosage forms is that all these devices are conceived for batch processes which do not allow for continuous or quasi-continuous operation and the recurrent transfer activities which are sometimes required are time-intensive, delay the process and require costly evacuation or encapsulation systems.

Therefore, the objective of the invention is to provide a device and a process which improve the product throughput speed in a multi-stage coating process without reducing the product reliability ensured by batch processes according to the state-of-the-art.

The objective is achieved by means of the device according to the present invention with the characteristics set forth in claim 1 or 9. Advantageous enhancements of the process and the device are characterised in the subclaims.

Device for coating solid forms comprising a perforated drum installed in a casing, a line for feeding the solid forms into the interior of the drum, at least one fluid line and nozzles for spraying fluids across the interior of the drum, the drum rotating about its horizontal axis during operation to move the mass of solid forms. The coating device also includes at least one gas evacuation line to remove moisture and dust from the coating device's casing and the interior of the drum.

The drum consists of several so-called segments (longitudinal drum sections) which are separated by a transport element and to each of which at least one fluid line is connected, these lines having nozzles attached which are used to spray the solid forms contained in the respective segment. The number of segments is optional and only dependent on the mechanical requirements to be met by the drum or the transport element and other internals.

The movement of the transport element is independent of the rotation of the drum, the solid forms being conveyed into the subsequent segment or out of the coating device in axial direction by the movement of the transport element.

In an optimised embodiment, the coating device according to the present invention is equipped with a cylindrical coil or helix as the transport element.

Ideally, the cylindrical coil is pivoted and the segments and the gradient of the cylindrical coil are designed so that at the most one single complete rotation of the cylindrical coil moves all of the solid forms from one segment on to the next or carries them out of the coating device. At the same time, the ideal radius for the cylindrical coil leaves a small gap between the inside wall of the drum and the outer edge of the cylindrical coil, the gap being smaller than or equal to half the smallest diameter of the solid forms to be coated and ideally smaller than one fifth of that diameter. In one embodiment of the device according to the present invention the segmenting element is installed in such a way that it rubs against the inner drum wall.

It is of advantage that the rotation of the drum and that of the cylindrical coil are completely independent of each other as regards rotary direction and speed.

In an improved embodiment of the coating device the segments are connected with one another via a continuous opening along the rotational axis inside the drum.

Ideally, each segment can be supplied with one or more process fluids independently of the adjacent segment.

In an improved embodiment of the invention one or several mixing elements are installed in at least one segment, and are freely movable so to allow them to be immersed into or lifted out of the bed of solid forms. In the immersed position, these mixing elements induce cross-mixing in the mass of solid forms agitated through rotation of the drum.

In a further improved embodiment of the device the mixing element is attached to the transport element which is shaped so to ensure that when the transport element moves and the solid forms are consequently conveyed in axial direction no solid form is lifted out of the mass.

Consequently, a particular advantage of the invention is that not one single solid form can exit a respective segment via a short-circuit flow before the end of a coating stage, which is absolutely essential for pharmaceutical products. The individual stages of the coating process are thus as clearly separated as in a familiar state-of-the-art batch device.

The transfer of the solid forms to the next coating stage or their discharge can be performed while the drum is either rotating or at a standstill, with the cylindrical coil being turned by half or at the most one rotation depending on the segment dimensions.

This utmost self-contained and simplified transport process is a great advantage for use in clean rooms as no additional emissions occur during transfer of the solid forms from one coating stage to the next.

The invention also includes a process for coating spherical particles for which the above described coating device according to the present invention is used.

The invention further includes the use of the coating device or the coating process for coating solid forms according to the present invention in processes for the manufacture of pharmaceutical or food products.

The coating device according to the present invention can thus be connected direct to the tablet press which is frequently arranged upstream and to the downstream primary packaging unit, such as a blister machine. This thus avoids interim storage with all the disadvantages associated with fragmentation and additional residence times. This thus allows for a self-contained process from the granules to the ready packaging, especially in the case of highly effective substances.

At the same time the disadvantages of a proper continuous manufacturing process are avoided as only defined partial batches are involved, allowing for exact spray rates and defined durations.

The drawing illustrates in detail the object of the invention by means of a typical embodiment.

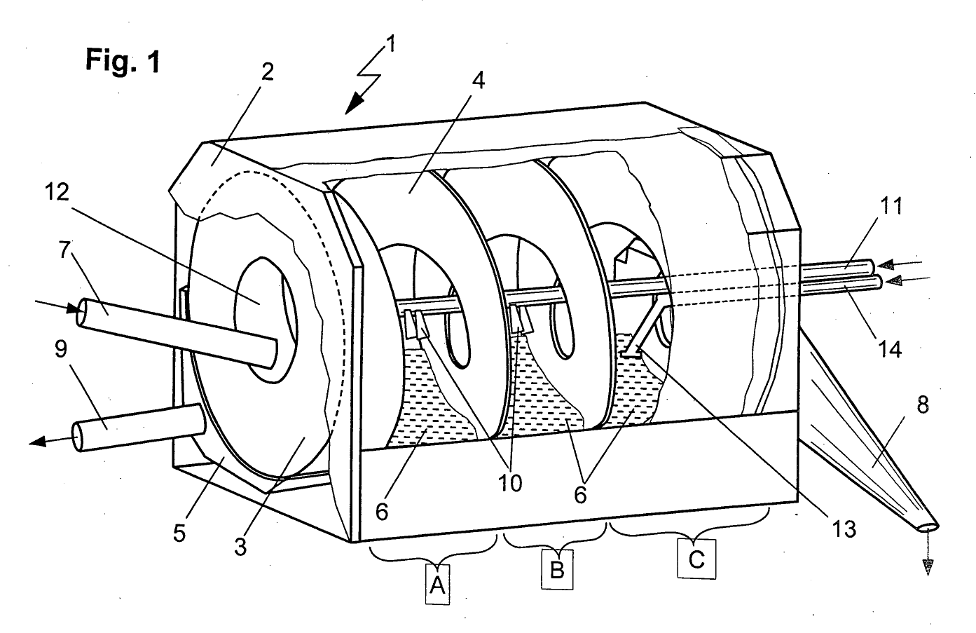

FIG. 1 shows the coating device 1 according to the present invention including an external casing 2 in which a pivoted perforated drum 3 is integrated. Drum 3 houses an open cylindrical coil 4, which divides the interior of the drum into three segments, A to C. The solid forms to be coated 6 are fed into segment A via the solid form feed line 7, and exit the coating device via line 8 when all coating stages in all segments have been completed.

FIG. 1 also shows an exhaust air element 5 in the form of a hull which subtends part of drum 3 with a very small gap between. This exhaust air element 5 is connected to a vacuum pump (not shown in the figure) via a gas evacuation line 9 and sucks the moisture and the dust from the inside of the casing 2 and primarily from the mass of solid forms 6 out through the perforated wall of drum 3.

During operation of the coating device 1, the solid forms 6 at the bottom of the mass are lifted via rotation of the drum 3 and, due to gravity, primarily those on the surface roll down to the bottom, i.e. the lowest point of the drum 3. The exhaust air element 5 is shaped so as to ensure primarily that it completely covers the back of the drum area covered by the solid forms 6 during operation.

The central space 12 close to the axis of drum 3, into which the walls of the cylindrical coil 4 do not project, is equipped with nozzles 10 which are supplied with fluid via line 11—with line 11 also serving as mounting for the nozzles 10 in the embodiment shown in the figure.

The nozzles are arranged in segments A and B where the coating liquid is sprayed onto the solid forms 6. In segment C the coated solid forms 6 are dried and cooled—with a gas suitable for optimising the drying and cooling process being introduced directly into segment C via a gas pressure line 14 and a gas outlet 13 in the embodiment shown in the diagram.

### KEY TO REFERENCED ITEMS

1 Coating device

2 Casing

3 Drum

4 Coil

5 Exhaust air element

6 Mass of solid forms

7 Solid form feed line

8 Solid form discharge line

9 Gas evacuation line

10 Nozzle

11 Fluid line

12 Space close to the axis

13 Gas outlet

14 Gas pressure line

A-C Drum segments

1-11. (canceled)

12. A coating device for coating solid forms, comprising a perforated drum integrated into a casing, a solid form feed line to feed the solid forms into the drum, at least one fluid line and nozzles for spraying fluids across the interior of the drum as well as at least one gas evacuation line—the drum rotating about its horizontal axis during operation and a gas evacuation line serving the casing and drum interiors, wherein
the drum is divided into several segments (longitudinal drum sections) by a device for transporting the solid forms,
there is at least one fluid line with nozzles attached connected to each segment for the purpose of spraying the solid forms contained in that respective segment,
the drum can be rotated independently of the movement of the element for transporting the solid forms, and
the solid forms can be conveyed into the subsequent segment or out of the coating device in the direction of the drum axis by the movement of the transport element.

13. The coating device according to claim 12, wherein the transport element for conveying the solid forms is designed as a cylindrical coil.

14. The coating device according to claim 13, wherein the cylindrical coil is pivoted and at the most a single complete rotation of the cylindrical coil moves the solid forms from one segment on to the next or carries them out of the coating device.

15. The coating device according to claim 14, wherein the rotation of the drum and that of the cylindrical coil are independent of each other as regards rotary direction and speed.

16. The coating device according to claim 12, wherein the transport element for the solid forms is installed in such a way that it rubs against the inner drum wall.

17. The coating device according to claim 13, wherein there is a gap between the inside wall of the drum and the outer edge of the cylindrical coil, the gap being smaller than or equal to half the smallest diameter of the solid forms to be coated and ideally smaller than one fifth of that diameter.

18. The coating device according to claim 12, wherein each segment can be supplied with one or more process fluids independently of the adjacent segment.

19. The coating device according to claim 12, wherein one or several mixing elements are installed in at least one segment and are freely movable so as to allow them to be immersed into or lifted out of the bed of solid forms.

20. A process for coating solid forms such as dragées, tablets, pastilles or suchlike using a coating device according to claim 12, wherein
in a first step, the solid forms are filled into the first segment,
in a second step, the solid forms are moistened with fluid in accordance with the specific requirements,
in the third step, the transport element is subjected to at the most one complete rotation, ensuring that the first segment is emptied and the solid forms are moved on to the next in axial direction,
in the fourth step, the first segment is refilled as per the first step, while—depending on the specific requirements—the solid forms in the second segment are either remoistened with fluid, cooled or heated—air or a gas being introduced direct into the segment or being sucked in through the perforations in the drum wall and distributed across the solid forms, and
in the fifth step, the transport element for solid forms is again subjected to at the most one complete rotation, the solid forms in the second segment thus being conveyed into the third and those in the first being conveyed into the second, and steps one to four being repeated as many times as required, the solid forms in the final segment of the coating device being discharged from the drum, and the drum rotating during the process and a gas evacuation line serving the interior of the coating device and the drum.

21. A method of utilizing the device according to claim 12, comprising using the device to manufacture pharmaceutical products.

22. A method of uitlizing the device according to claim 12, comprising using the device to manufacture food products.
